(19) United States
(12) Patent Application Publication
(10) Pub. No.: US 2020/0300476 A1
(43) Pub. Date: Sep. 24, 2020

(54) COOKING DEVICE WITH A SHORT-RANGE RADIO INTERFACE

(71) Applicant: BSH Hausgeräte GmbH, Munich (DE)

(72) Inventors: Ralf Grobleben, Bretten (DE); Gernot Oberfell, München (DE); Tobias Schmidt, München (DE); Jan Wertel, Berlin (DE)

(21) Appl. No.: 16/088,835

(22) PCT Filed: May 2, 2017
(86) PCT No.: PCT/EP2017/060331

§ 371 Date: Sep. 27, 2018

(30) Foreign Application Priority Data
May 25, 2016 (DE) 102016209133.6

(51) Int. Cl. F24C 7/08; G08C 17/02; F24C 15/10

(52) U.S. Cl. CPC F24C 7/085; G08C 2201/93; F24C 15/105; G08C 17/02

(57) ABSTRACT

A cooking device has a short-range radio interface, a control device for operating the cooking device, which control device is designed to receive data for operating the cooking device from a transponder via the short-range radio interface, and at least one active positioning area for detachably fastening at least one transponder. The active positioning area is located in a communication region of the short-range radio interface. The control device receives authorization data from the transponder via the short-range radio interface and operates the cooking device with corresponding use authorization on the basis of the authorization data.

The invention relates to a cooking appliance, having a short-range radio interface, a control device for operating the cooking appliance, which is designed to receive data for operating the cooking appliance from a transponder by way of the short-range radio interface, and at least one active positioning surface for arranging at least one transponder, located in a communication region of the short-range radio interface. The invention also relates to a mechanically actuatable operating element of a cooking appliance. The invention also relates to a method for operating a cooking appliance. The invention can be used particularly advantageously for cooking appliances, which have an oven or are an oven.

DE 10 2008 041 394 A1 discloses that a contactlessly readable identification tag is provided with data stored thereon relating to a product, the data comprising at least one item of sale information relating to the sale of the product and at least one item of product information relating to the type and/or handling of the product. The sale information is stored unencoded and the product information is stored encoded. A domestic appliance is designed to display read sale information unencoded on the display unit and to control the handling process based on read encoded product information. To this end a method comprises the step of displaying sale information relating to the sale of the product contained in the read data on a display unit in clear text, as well as the step of controlling a handling process based on encoded product information contained in the read data.

EP 0 986 240 B1 discloses a domestic appliance with a primary domestic function of “cooking, defrosting or freezing”, which is however also designed for a secondary function of “interaction” with a communication network, the appliance comprising a user interface, which can be operated by direct contact with the appliance, and a remote control device, which can be operated by a remote control handset, activation or deactivation of the primary function of the appliance being reserved for the user interface and the remote control device being able to monitor the secondary function and also a part of the primary function of the appliance but not able to activate or deactivate the primary function.

DE 10 2012 101 536 B3 relates to a domestic appliance with a panel and/or a housing, and a control device for operating the domestic appliance, with a communication device with means for data transmission and for providing an active connection to a mobile device with an operating and display device. In order to allow user-friendly handling with the mobile device, the domestic appliance comprises a holding apparatus which is mounted in such a manner that it can be folded out from the outer surface of the panel or a housing wall and is suitable for positioning or securing the mobile device on the panel or housing in the active region of the means for data transmission.

WO 2009 153 708 A1 discloses a programming system for programming an interactive system. It comprises a tag control arrangement tag with a smart tag communication interface and a set of individual smart tags, each having a control arrangement communication interface, an assignment interface for allocating functional properties and a display for displaying information relating to the functional properties. The programming system is implemented in such a manner that a control sequence for the interactive system is based on the functional properties assigned to the smart tags during a programming session. Also described are a method for programming an interactive system, a smart tag, a set of smart tags, a tag control arrangement, an interactive system, the use of a smart tag for programming an interactive system and a computer program product.

DE 10 2006 039 926 A1 discloses a domestic appliance with a read device and at least one information card, the information card containing a code arrangement that can be read by the read device and serves to control the domestic appliance. The code arrangement is made of conductive organic polymers.

U.S. Pat. No. 7,258,064 B2 discloses a food time control system comprising a number of time control modules assigned to food storage apparatuses in a restaurant. The time control modules are connected in a network so that they can communicate information relating to food in food compartments of the food storage apparatuses. Each time control module contains a plurality of timers, each timer being assigned to a food compartment of a food storage apparatus. The timers measure the time the food is stored in each food compartment and they are able to transmit the storage time to another timer if food is added to a food compartment to which another timer is assigned.

It is the object of the present invention to at least partially overcome the disadvantages of the prior art and in particular to provide a cooking appliance with an oven that allows improved, in particular safer, operation.

This object is achieved according to the features of the independent claims. Preferred embodiments will emerge in particular from the dependent claims.

The object is achieved by a cooking appliance, having a short-range radio interface, a control device for operating the cooking appliance, which is designed to receive data for operating the cooking appliance from a transponder by way of the short-range radio interface, and at least one surface (referred to in the following without restricting its general nature as an “active positioning surface”) for the detachable fastening of at least one transponder, which is located in a communication region of the short-range radio interface, the control device being designed to receive authorization data from the transponder by way of the short-range radio interface and to operate the cooking appliance with corresponding use authorizations based on the authorization data.

This cooking appliance has the advantage that its operation can be individualized particularly easily and can be adjusted to particular skills and needs of defined operators. In particular users can be assigned respective transponders, which either allow unrestricted operation of the cooking appliance or (for example for children or adults with dementia) only restricted operation of the cooking appliance. To set the respective operation of the cooking appliance just one corresponding transponder has to be located in the communication region of the short-range radio interface, in particular being fastened to the active positioning surface.

In one embodiment the cooking appliance has an oven or is an oven. The cooking appliance can be a separate oven or an oven/cooktop combination or cooker. The oven can have a steam supply functionality and/or a microwave functionality.

In one development the cooking appliance is a domestic cooking appliance, in particular a kitchen appliance. The cooking appliance is in particular an electrically driven cooking appliance.

A transponder refers in particular to a radio communication device that receives and automatically responds to signals arriving from the short-range radio interface of the cooking appliance. It can thus communicate with the short-range radio interface of the cooking appliance. The transponder can be a passive transponder or an active transponder. The transponder can be an RFID transponder.

The short-range radio interface can be configured for example as a radio receiver or as a combined radio transmitter/receiver. The short-range radio interface can be configured as an RFID read device.

The short-range radio interface may in particular have a range of no more than approx. 10 cm. This actively prevents unwanted influencing of the cooking appliance with different transponders or communication with transponders further away.

The short-range radio interface can in particular be an NFC interface and can thus be designed to communicate with the transponder according to the NFC standard. The transponder is then an NFC transponder.

The communication region of the short-range radio interface is the spatial region in front of the cooking appliance, where a transponder can typically communicate with the short-range radio interface. It is defined by the range of the short-range radio interface.

The control device can be designed, for example programmed, to allow cooking operations, in particular cooking programs, to be performed on the cooking appliance. The control device can be coupled to an operating device for the purposes of receiving user input from it and outputting user instructions via it, for example relating to cooking times, current settings, etc. The control device is also coupled to the short-range radio interface for the purpose of receiving at least data via it. The control device can have at least one integrated circuit, for example a microprocessor, microcontroller, ASIC, FPGA, etc.

Detachable fastening can mean in particular that the transponder can be held, fixed or latched to the cooking appliance with a force fit. Detachable fastening may not mean in particular that the transponder is simply placed on the cooking appliance, stood thereon or inserted therein.

In one embodiment generally the control device is designed to operate the cooking appliance with restricted functions and/or parameters based on the authorization data. Authorization data can therefore in particular refer to data the control device can use to block or allow defined functions and/or parameters of the cooking appliance. The blocking of a function or parameter can comprise or mean restricting the function or parameter, for example to a restricted value range. Operating the cooking appliance with corresponding use authorizations can therefore mean in particular only being able to operate the cooking appliance with permitted or not-blocked functions and/or parameters. This embodiment allows the setting up of a particularly wide range of use authorizations.

The functions can be defined cooking programs and/or cooking functions. The parameters may be defined heating or cooking parameters. The authorization data for a user may therefore specify that said user is only allowed to operate defined cooking programs, such as heating-up programs or the like and/or to set an oven temperature of no more than 80° C. Alternatively or additionally the functions can comprise or be non-cooking programs, such as pyrolytic self-cleaning, transponder programming (as described in more detail below), timer setting, etc. Thus pyrolytic self-cleaning can be blocked for children, etc.

In a further embodiment the control device is designed only to operate the cooking appliance when the transponder is located in the communication region of the short-range radio interface. This prevents a user being able to operate the cooking appliance without the transponder, thereby possibly circumventing restricted authorizations.

Alternatively the control device can be designed only to operate the cooking appliance with restricted use authorizations when there is no transponder in the communication region of the short-range radio interface. A transponder can then selectively allow the set of otherwise blocked functions and/or operating parameters, according to the authorization data received from the transponder. However the control device can also be designed optionally to operate the cooking appliance independently of received authorization data and thus not to use the option of use-restricted operation.

In a further embodiment the control device is designed to program the transponder by way of the short-range radio interface. This has the advantage that users themselves can at least also determine the content that can be read from the transponders. To this end the transponder is configured so that it can be programmed by way of the short-range radio interface. This embodiment can be seen as a separate way of achieving the object, which can also represent an invention independently of an authorization function or authorization assignment.

In one development the control device is designed to require a password to program a transponder, for example by means of an input by a user at an input device, for example by way of a touch-sensitive screen or by way of a keypad of the cooking appliance. The password can be supplied with the cooking appliance for example. Alternatively or additionally the control device can be designed to request or require the presence of another transponder in the communication region of the short-range radio interface in order to program the transponder, this other transponder allowing such programming or being able to transmit authorization data for programming a transponder to the cooking appliance.

In a further embodiment the control device is designed to program the transponder with authorization data selected at the cooking appliance. Thus users themselves can assign transponders with individually set authorizations for other users and/or change their authorizations. The control device can be designed in particular to enable or perform programming of the transponder by means of a corresponding menu controller. Thus a user can select the content installed on the transponder and/or deleted from the transponder particularly easily.

In one development the control device is designed to program the transponder with non-authorization data, for example with cooking programs or recipes. This makes an exchange of recipes between different users particularly easy to set up. For example if a user has particularly successfully adapted a preprogrammed recipe or program sequence or created a new recipe or new program sequence, said user can program said recipe or program sequence on the transponder and transmit it to another cooking appliance for example for a friend, cookery group, etc. A transponder can also thus be programmed with cooking programs or recipes in the factory or by a third-party supplier and then sent to users. This allows a publisher for example, publishing a cookery magazine or cookery book, to program a transponder and send it to interested users, for example as part of a publicity campaign.

In principle the transponder can be such that it can be programmed with authorization data by a user and it can also have data that cannot be programmed at least by the user. Data that cannot be programmed by the user can be read or called up by the cooking appliance but cannot then be reprogrammed by an end user. The transponder therefore has a read-only or demand-only function. This can be implemented in such a manner that the transponder has been set up correspondingly by the issuing body (e.g. a kitchen appliance manufacturer, cookery studio, magazine, etc.).

In one development the transponder only has readable or non-programmable data. This can comprise or be authorization data at least to some degree.

The transponder can have essentially any configuration, in which an RFID structure for example is cast or inlaid in a plastic volume. The transponder, in particular its plastic volume, can have a symbolic shape, for example a pepper for transponders preprogrammed with vegetable recipes, a lettuce for transponders preprogrammed with raw food recipes, a fish for a transponder programmed with fish recipes, etc. A transponder can also be present in the form of a company logo, a slogan, etc., for example for advertising purposes. The transponder can also be present in the form of a name or family designation, for example “Mum”, “Grandma”, “Helen”, “Anne”, etc.

In another embodiment the transponder is a removable mechanically actuatable operating element. This allows an operating element to be provided, to which individual authorizations for operating the cooking appliance are assigned. There is then no need for separate transponders. Such a transponder can also be seen as a multifunctional operating element of a cooking appliance. A mechanically actuatable operating element can be actuated or moved mechanically by a user.

In another embodiment the mechanically actuatable transponder is a knob. This has the advantage that it has great operational versatility while taking up little space. In one development the knob is a magnetically detachable knob. This has the advantage that it can be rotated without further measures. In one variant the knob can also be moved to the side, for example in the manner of a slider, to initiate associated functions. The cooking appliance can in particular detect a position, in particular an angular position, and/or a change in an angular position or rotation of the knob magnetically, for example by means of at least one Hall sensor. A mechanically actuatable operating element can alternatively be a slider for example. A button or touch-sensitive screen in particular cannot represent a mechanically actuatable operating element.

Alternatively or additionally the knob can be fastened in a mechanically detachable manner, for example to a clamping apparatus or latching apparatus of the cooking appliance. To this end the knob can be connected to the remainder of the cooking appliance, for example by way of a stem.

The transponder described above can be seen as part of the cooking appliance, in particular if it is also configured as an operating element. The transponder described above can however also be seen as a separate apparatus that achieves the stated object independently. The object can therefore also be achieved in particular by a mechanically actuatable operating element of a cooking appliance, the operating element being configured as a transponder communicating with the short-range radio interface of the cooking appliance that can send authorization data for operating the cooking appliance with corresponding use authorizations to the cooking appliance.

In another embodiment the active positioning surface has a magnetically active fastening surface. This allows a similarly magnetically active transponder to be fastened magnetically in a detachable manner to the active positioning surface. This has the advantage that the active positioning surface can be configured as flat and therefore in particular without bearing projections, hollows, hooks, edges, etc. It also means that the transponder can be attached particularly easily. The transponder can also be moved, for example rotated or moved to the side.

In one development the active positioning surface has at least one magnet, for example at least one permanent magnet or electromagnet. It can alternatively have at least one magnetically attractable but itself not permanently magnetic material, for example iron. It can be configured for example as a steel or iron plate or can have such a plate. The transponder can have at least one permanent magnet to establish a magnetic attraction force to the active positioning surface, alternatively or additionally at least one non-permanently magnetic volume of magnetizable material, for example iron, steel, etc.

In another embodiment the cooking appliance has a passive fastening surface for the detachable fastening of transponders located outside the communication region of the short-range radio interface. This passive fastening surface—which like the active fastening surface can in particular be magnetically active—allows easy storage of transponders not currently in use, which therefore no longer have to be moved.

The active fastening surface and the passive fastening surface can be located on opposing sides of an operating region of the cooking appliance, for example on the left and right thereof. The operating region can comprise one or more touch-sensitive screens or touchscreens and/or one or more switches (mechanical switches such as short stroke switches, knobs, etc.).

The active fastening surface and in some instances the passive fastening surface can be regions of an operating panel. The operating panel can be a stationary operating panel. Alternatively the operating panel can be part of a cooking appliance door.

In one advantageous embodiment of the cooking appliance, particularly if the transponder is configured as a knob, the active positioning surface is a front surface, the cooking appliance has a screen arranged at the front and the transponder partially conceals the screen when fastened to the active positioning surface. This offers a particularly compact arrangement, allowing convenient appliance control and/or appliance setting. The transponder can be fastened, in particular magnetically fastened, for example in the region of an upper edge, a lower edge, a left edge and/or a right edge of the screen. The transponder here may only be fastened to the region of the cooking appliance, in particular of its operating panel, which is located away from the screen.

The object is also achieved by a method for operating a cooking appliance, in particular as described above, in which a transponder is brought into a communication region of a short-range radio interface of a cooking appliance, then authorization data is transmitted from the transponder to the cooking appliance by way of the short-range radio interface and a control device uses said authorization data to operate the cooking appliance with corresponding use authorizations. The method can be configured in the same way as the apparatuses described above and has the same advantages.

Therefore in one embodiment a transponder fastened in a detachable manner to a passive fastening surface is moved to the active fastening surface, data communication is performed there between the transponder and the short-range radio interface of the cooking appliance and the transponder is then moved back to the passive fastening surface.

The properties, features and advantages of the present invention and the manner in which they are achieved will become clearer and more readily comprehensible in conjunction with the following schematic description of an exemplary embodiment described in more detail with reference to the drawings, in which

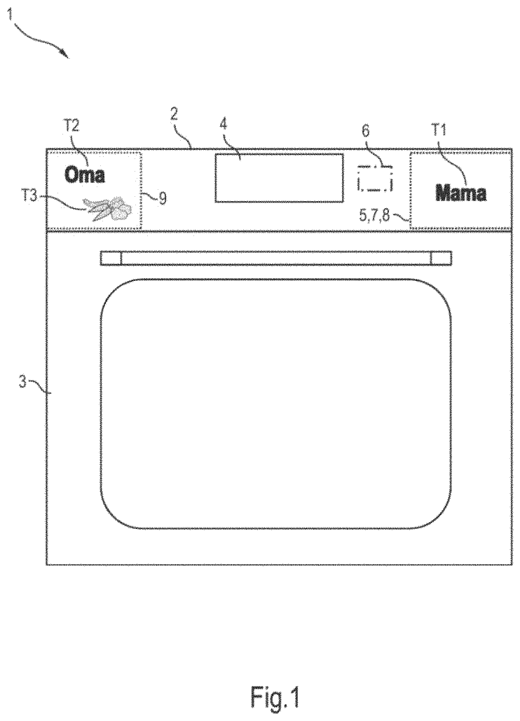

FIG. 1 shows a front view of a front face of a cooking appliance according to a first exemplary embodiment with transponders arranged thereon; and

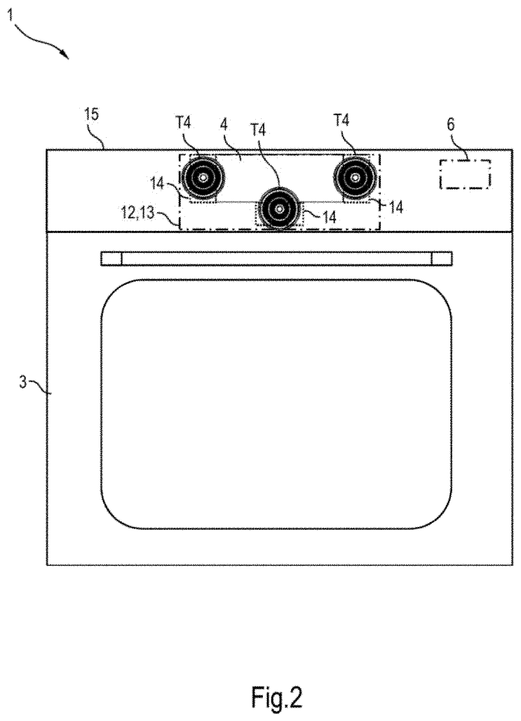

FIG. 2 shows a front view of a front face of a cooking appliance according to a second exemplary embodiment with a transponder arranged thereon

FIG. 1 shows a front view of a cooking appliance in the form of an oven 1 with a number of transponders T1, T2 and T3 arranged thereon. The top of the oven 1 can be connected to a cooktop and the two then form a cooker. The oven 1 has a stationary front operating panel 2, below which a front door 3 closing off an oven space is located. The operating panel 2 has an operating and display element in the form of a touch-sensitive screen 4 in its center.

The oven 1 has an NFC interface 5 and a control device 6 for operating the oven 1 on its operating panel 2. The control device 6 is designed inter alia to receive data for operating the oven 1 from a transponder T1, T2 or T3, specifically here the transponder T1 (in the form of the word “Mum”), located on a front active fastening surface 7 (NFC active zone) of the operating panel 2. The active fastening surface 7 is located in a communication region 8 of the NFC interface 5, which here corresponds at least approximately to a front surface of the NFC interface 5 but can also be for example larger than said surface. The transponder T1 can therefore be called up from the NFC interface 5. The transponder T1 is in particular a passive transponder, configured for example as an RFID tag.

The transponder T1 is designed to send authorization data to the NFC interface 5. The control device 6 is designed to use authorization data received from the transponder T1 by way of the short-range radio interface 5 to operate the oven 1 (and optionally the cooktop) with corresponding use authorizations. The control device 6 here is designed so that it only operates the oven 1 when a transponder T1 to T3 is located in the communication region 8 of the NFC interface 5.

The transponders T1 to T3 have permanently magnetic regions, with which they can be fastened magnetically in a detachable manner to the active fastening surface 7. In order therefore to be able to operate the oven 1 with a defined set of authorizations, a correspondingly programmed or configured transponder T1 to T3 is positioned on the active fastening surface 7. The transponder T1 can for example have or hold authorization data which allows unrestricted operation of the oven 1. The transponder T2, in the form of the word “Grandma” here, may only allow restricted operation of the oven 1, for example just a heating-up operation. Transponder T1 and transponder T2 in particular cannot be used at the same time. Transponder T3 does not hold authorization data, just vegetable recipes for example, and is formed in a corresponding symbolic manner. Transponder T3 can be operated together with the other transponders T1 or T2 and can be fastened magnetically to the active fastening surface 7 with them for this purpose.

Transponders T2, T3 currently not in use can be fastened magnetically and therefore detachably to a passive fastening surface 9 (NFC passive zone). The passive fastening surface 9 is located away from the communication region 8, so that the oven 1 cannot call up the transponders T2, T3 there. While the passive fastening surface 9 is located to the left of the touch-sensitive screen 4 in the front view, the active fastening surface 7 is located to the right of the touch-sensitive screen 4 symmetrically to it.

If a transponder T1 to T3 is located on the active fastening surface 7, in a corresponding embodiment it can be programmed by means of the oven 1, more specifically by means of the control device 6 by way of the short-range radio interface 5. Programming can take place for example in a menu-controlled manner by way of the touch-sensitive screen 4. The transponder T1 to T3 can be programmed for example with authorization data and/or with cooking parameters or recipes, etc. It is however also possible for it not to be possible to change or reprogram the authorization data stored on the transponder T1 as “master”. The transponder T3 may not be programmed with authorization data but with recipes, etc. Alternatively the transponder T1 and/or the transponder T3 is/are not programmable.

FIG. 2 shows a front view of an oven 11 configured in a similar manner to the oven 1, with a transponder T4 arranged thereon in a number of possible, alternative positions. The transponder T4 is configured as a magnetically adhering knob. The oven 11 can identify at least one rotation of the transponder T4 and process it as a user input.

An NFC interface 12 or its communication region 13 here runs in a U-shape round the sides and bottom of the touch-sensitive screen 4. Three active fastening regions 14 adjoin the touch-sensitive screen 4, specifically in the region of a lower edge, a left edge or a right edge of the touch-sensitive screen 4. The transponder T4 can be positioned on the operating panel 15 there, thereby partially concealing the touch-sensitive screen 4. A passive fastening surface can be provided but does not have to be.

The transponder T4 can also be conceived as a magnetically fastenable knob, which has a transponder function. The transponder function allows it to prompt the control device 6 for example to allow unrestricted or restricted use of the oven 1 based on called up authorization data. Different transponders T4 can thus be assigned to different users with different use authorizations. If there is no transponder T4 present, the oven 11 is switched off.

The transponder T4 may also be programmable, for example with authorization data. In some instances an oven 11 can be supplied with a number of transponders T4, of which all or just some can be programmed with authorization data.

The present invention is of course not restricted to the illustrated exemplary embodiment.

The communication region can therefore also take a different form from the NFC interface, in particular being much greater in size.

Generally “one” can refer to a single one or a plurality, in particular in the sense of “at least one” or “one or more”, etc., unless this is specifically excluded, for example by the expression “just one”.

A number can also refer to just the specified number as well as a standard tolerance range, unless this is specifically excluded.

### LIST OF REFERENCE CHARACTERS

1 Oven
2 Operating panel
3 Door
4 Touch-sensitive screen
5 NFC interface
6 Control device
7 Active fastening surface
8 Communication region
9 Passive fastening surface
11 Oven
12 NFC interface
13 Communication region
14 Active fastening surface
15 Operating panel
T1-T4 Transponder

1-14. (canceled)

15. A cooking appliance, comprising:
a short-range radio interface,
a control device configured to receive authorization data from a first transponder by way of the short-range radio interface and to operate the cooking appliance with a corresponding use authorization based on the authorization data, and
an active positioning surface for detachably fastening the transponder located in a communication region of the short-range radio interface.

16. The cooking appliance of claim 15, wherein the control device is configured to only operate the cooking appliance when the first transponder is located in the communication region of the short-range radio interface.

17. The cooking appliance of claim 15, wherein the control device is configured to operate the cooking appliance with restricted function and/or operating parameter based on the authorization data.

18. The cooking appliance of claim 15, wherein the control device is configured to program the first transponder by way of the short-range radio interface.

19. The cooking appliance of claim 15, wherein the control device is configured to program the first transponder with authorization data selected at the cooking appliance.

20. The cooking appliance of claim 15, wherein the active positioning surface is a magnetically active fastening surface.

21. The cooking appliance of claim 15, further comprising a passive fastening surface for detachably fastening a second transponder located outside the communication region of the short-range radio interface.

22. The cooking appliance of claim 21, wherein the second transponder is a mechanically actuatable operating element of the cooking appliance.

23. The cooking appliance of claim 22, wherein the second transponder is a knob.

24. The cooking appliance of claim 23, wherein the active positioning surface is a front surface, and further comprising a screen arranged at the front surface, said knob partially concealing the screen when fastened to the active positioning surface.

25. The cooking appliance of claim 15, further comprising an oven.

26. The cooking appliance of claim 15, constructed in the form of an oven.

27. A mechanically actuatable operating element of a cooking appliance, said operating element configured as a transponder communicating with a short-range radio interface of the cooking appliance and configured to send authorization data for operating the cooking appliance with a corresponding use authorization to the cooking appliance.

28. A method for operating a cooking appliance, comprising:
placing a first transponder into a communication region of a short-range radio interface of the cooking appliance,
transmitting authorization data from the first transponder to the cooking appliance by way of the short-range radio interface, and
operating the cooking appliance by a control device in response to the authorization data with a corresponding use authorization.

29. The method of claim 28, further comprising:
moving a second transponder detachably fastened to a passive fastening surface to an active contact surface,
executing a data communication between the second transponder and the short-range radio interface of the cooking appliance, and
moving the second transponder back to the passive fastening surface.
